(19) United States
(12) Patent Application Publication
(10) Pub. No.: US 2022/0309200 A1
(43) Pub. Date: Sep. 29, 2022

(54) DYNAMIC INTERACTIVE SIMULATION METHOD FOR RECOGNITION AND PLANNING OF URBAN VIEWING CORRIDOR

(71) Applicant: SOUTHEAST UNIVERSITY, Nanjing, Jiangsu (CN)

(72) Inventors: Junyan YANG, Nanjing, Jiangsu (CN); Xiao ZHU, Nanjing, Jiangsu (CN); Yi SHI, Nanjing, Jiangsu (CN); Qingyao ZHANG, Nanjing, Jiangsu (CN); Xun ZHANG, Nanjing, Jiangsu (CN); Beixiang SHI, Nanjing, Jiangsu (CN)

(21) Appl. No.: 17/610,042

(22) PCT Filed: Oct. 29, 2020
(86) PCT No.: PCT/CN2020/124624

§ 371 Date: Nov. 9, 2021

(30) Foreign Application Priority Data
Sep. 10, 2020 (CN) 202010946537.2

(51) Int. Cl. G06F 30/13; G06F 30/20

(52) U.S. Cl. CPC G06F 30/13; G06F 30/20; G06F 2111/18

(57) ABSTRACT

The present invention discloses a dynamic interactive simulation method for recognition and planning of an urban viewing corridor. The method includes: constructing a sand table of morphology data of an urban space around an urban viewing point; creating a visual sphere, calculating a blocking point set, acquiring a three-dimensional view field of the viewing point, and obtaining an effective projection plane of a sight line of the viewing point; extracting a visual three-dimensional road model, calculating projection curvatures of road centerlines at points equidistant from each other, and screening and recognizing a viewing corridor; collecting a real scene, and inputting the collected real scene to a three-dimensional interactive display platform; inputting a new planning scheme to the three-dimensional interactive display platform, and simulating an urban viewing corridor with the planning scheme superimposed; and outputting, by using augmented reality glasses, a dynamic interactive VR scene of the urban viewing corridor space after the urban planning scheme is superimposed. The present invention combines a real dynamic viewing process, and uses a three-dimensional interactive display platform for planning simulation and interactive output, thereby providing a basic rational support for further optimization and decision-making of urban planning and design.

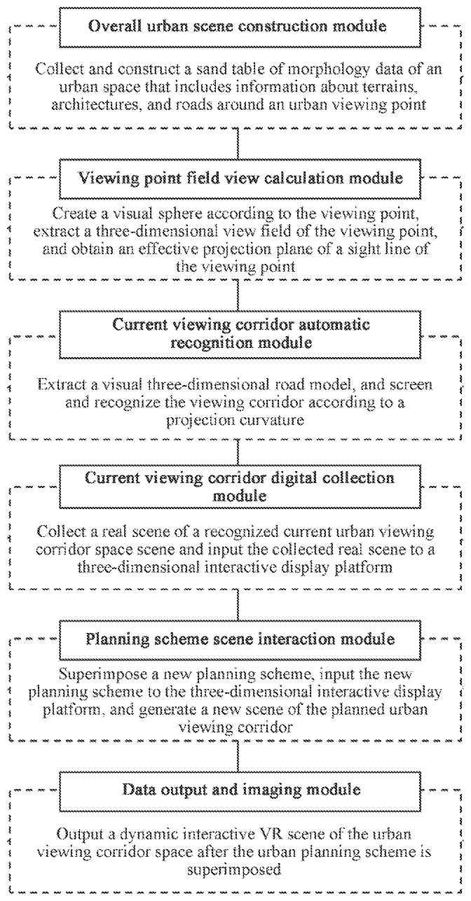

### TECHNICAL FIELD

The present invention relates to the field of urban planning, and in particular, to a dynamic interactive simulation method for recognition and planning of an urban viewing corridor.

### BACKGROUND

The urban viewing corridor reflects visibility of the public for an urban landscape element in a built environment, and is related to the spatial feeling and comfort level of urban public life. In urban planning and design, a quantitative result of the urban viewing corridor is used as an indicator, which is helpful to urban planning and design decision-making. In addition, the quantitative result may also be used as an important basis for the control and optimization of the layout of the urban space. By optimizing the visible viewing area in the current urban space environment, the perception of urban landscape may be effectively strengthened, and the quality of urban space can be improved. In this way, the public can “see the mountains and water” in the city, thereby achieving a harmonious state between the city and nature as a whole. A visual scene of a viewpoint in the existing viewing corridor of the city is analyzed, and the view field situation of the landscape in combination with the planning scheme is further calculated and simulated on this basis. This process is the first and important technical link for the urban planning and construction department to regulate and control the urban viewing corridor.

The existing analysis technologies of urban viewing corridor mainly include a landscape evaluation method based on manual field survey, a computer viewing image analysis method based on street view pictures, a geographic information system (GIS) view field analysis method based on digital modeling, and the like. The landscape evaluation method based on manual field survey generally is simply describing and evaluating the urban viewing corridor according to results of the current field survey by using an appropriate simple quantitative evaluation method. The computer viewing image analysis based on street view pictures is sampling street view pictures of the urban landscape corridor space on map sites such as Baidu Street View and Tencent Street View. Based on the artificial intelligence image recognition technology, the computer automatically recognizes the element of a viewing point (such as a mountain and an architecture) in the picture, and calculates a proportional relationship between the landscape element and other elements in a single street view picture to obtain a value of the visible viewing area. The GIS view field analysis based on digital modeling is recognizing a visual range of a point in the three-dimensional space in the existing digital elevation model, and the visual range of a plurality of points may be superimposed, so as to obtain a visibility grading map of the terrain.

However, there are some limitations on the accuracy, authenticity, and interactivity of the above several main analysis technologies for the urban viewing corridor. The landscape evaluation method based on manual field survey lacks certain accuracy. The method is mainly recognizing and evaluating the viewing corridor by people, which is subjective and lacks precision and cannot obtain quantitative and stereotype conclusions. Therefore, low accuracy of the results greatly restricts the application range of the method. The computer viewing image analysis technology based on street view pictures lacks interactivity. The street view image data used in the method includes only the visual image of the current street space of the city. On the one hand, due to the limitations of the data itself, the data fails to achieve full coverage of all landscape corridors and possible viewing points in the city, and cannot cover the planned urban space. An optimized response is made for incapability of interaction for the viewing corridor as a result of the planning scheme. The GIS view field analysis based on digital modeling lacks authenticity. During the analysis, the distribution of existing built-up architectures and the height of point of view of people are basically ignored. In addition, the method cannot reflect the continuous dynamic landscape perception, and therefore lacks the authenticity and applicability that sight line analysis should have.

### SUMMARY

Objective of the invention: In view of the above problems, the present invention provides a dynamic interactive simulation method for recognition and planning of an urban viewing corridor. Based on the construction of the existing built urban environment of a city, the current viewing corridor is recognized based on the view field calculation of the viewing point, so as to guarantee the accuracy of the recognition analysis of the current viewing corridor by using a quantitative method. Further, the urban landscape perception situation of the continuous dynamic viewpoint in the planned viewing corridor space is simulated and analyzed. In a way of dynamic interaction and in combination with the real dynamic viewing process, a three-dimensional interactive display platform is used for planning simulation and interactive output, which provides a basic rational support for the further optimization and decision-making of urban planning and design.

Technical solutions: According to the present invention, the dynamic interactive simulation method for recognition and planning of an urban viewing corridor includes the following steps:

(1) constructing a sand table of morphology data of an urban space around an urban viewing point based on vector data including terrains, architectures, and roads;

(2) creating a visual sphere according to the viewing point and a maximum visual distance, calculating a blocking point set, acquiring a three-dimensional view field of the viewing point, and obtaining an effective projection plane of a sight line of the viewing point;

(3) extracting a visual three-dimensional road model, calculating projection curvatures of road centerlines at points equidistant from each other, and screening and recognizing a viewing corridor;

(4) collecting a real scene of a recognized current urban viewing corridor space by using a backpack three-dimensional laser scanner, and inputting the collected real scene to a three-dimensional interactive display platform;

(5) inputting a new planning scheme to the three-dimensional interactive display platform, and simulating an urban viewing corridor with the planning scheme superimposed; and

(6) outputting, by using augmented reality glasses, a dynamic interactive VR scene of the urban viewing corridor space after the urban planning scheme is superimposed.

Further, step (1) includes the following steps:

(11) acquiring coordinates 0 (x, y, z) of the viewing point, where (x, y) are coordinate values of a plane where the viewing point is located, and z is a plane height of a highest point of a scene object where the viewing point is located; acquiring two-dimensional vector data including information about an urban terrain, an architecture, and a road within a certain range around an observation point, where the architecture data is a closed polygon and includes information about a quantity of architecture storeys, and the road data includes information about a centerline, a road width, and a road elevation of each road;

(12) adjusting coordinates of the vector data to be consistent, loading the coordinates into a SuperMap platform, and performing stretching by using a storey height of 3 m based on the information about the architecture storeys, to obtain a three-dimensional architecture model; and generating a three-dimensional road model based on the information about the road centerline and the road elevation point and the road width value, so as to establish a basic sand table of the morphology data of the urban space; and

(13) rasterizing, based on the obtained basic sand table of the morphology data of the urban space, a surface without the three-dimensional architecture model that is deemed a ground plane.

Further, step (2) includes the following steps:

(21) creating a visual sphere according to the coordinates O (x, y, z) of the viewing point: creating the visual sphere by using a maximum visible distance R in a current environment as a radius, and drawing a vertical line from a center of the sphere to a surface of the sphere at an interval of an azimuth angle α, where the vertical line is deemed the sight line for observing the viewing point;

(22) acquiring a point of intersection O₁ (x₁, y₁, z₁) of each generated azimuth line and the covered three-dimensional architecture model in the sphere, where the point of intersection is deemed the blocking point of the sight line, and forming a blocking point set N{O₁, O₂, O₃, . . . , On}; and connecting all blocking points in the point set to acquire the three-dimensional view field of the viewing point; and

(23) performing upward lifting in unit of 1.6 m based on ground plane grids of the sand table, where the obtained plane grids are deemed a human viewing plane where the observation point is located; and performing projection onto the human viewing plane in a y-axis direction according to the three-dimensional view field of the viewing point, where an obtained projection plane is denoted as the effective projection plane of the sight line of the viewing point.

Further, step (3) includes the following steps:

(31) calculating a point of intersection of the obtained effective projection plane of the sight line of the viewing point and the three-dimensional road model, and intercepting a road unit model in an effective sight line;

(32) extracting a centerline of the intercepted road unit model, and dotting the centerline equidistantly at an interval of 2 m to obtain a point set n{P₁, P_{2,} P₃, . . . , Pₙ}, where coordinates of a midpoint Pᵢ are (Xᵢ, Yᵢ, Zᵢ), and connecting adjacent points in the point set to form a continuous polyline; calculating a projection curvature Kₚ of the centerline on a horizontal plane, where a calculation formula is as follows:

$${K}_{P} = ( {\sum }_{i = 1}^{n - 1} arccos \frac{{r}_{i} \cdot {r}_{i + 1}}{\vert {r}_{i} \vert \cdot \vert {r}_{i + 1} \vert} ) {( {\sum }_{i = 1}^{n} \vert {r}_{i} \vert )}^{- 1}$$

where n is a total quantity of points in the set {P₁, P_{2,} P₃, . . . , Pn}, i=0, 1, . . . , n, the points are arranged in ascending order according to a coordinate z of the midpoint Pᵢ(Xᵢ, Yᵢ, Zᵢ), rᵢ is a vector of a line connecting adjacent points, and

rᵢ=\vec{Pᵢ₋ₗPᵢ}=(xᵢ−xᵢ₋ₗ, yᵢ−yᵢ₋ₗ, zᵢ−zᵢ₋ₗ) , i=1,2 , . . . , n; and

(33) eliminating a three-dimensional road model having Kₚ>4/km according to the calculated road projection curvature, and using a remaining three-dimensional road model as a current viewing corridor of the viewing point.

Further, step (4) includes the following steps:

(41) inputting the viewing corridor automatically recognized in step (3) to a two-dimensional plane database, placing a 5 m*5 m flat grid in the database, and determining a real scene collection route according to the viewing corridor space in the planning scheme, so as to serially connect, by a shortest path, all streets and public spaces where the viewing corridor is located;

(42) assembling a wearable high-precision three-dimensional scanner at a starting point of the collection route, where the scanner is required to have a lidar and a panoramic camera for collection, the scanning accuracy of the lidar is required to reach 300,000 dots per second, and a resolution of the panoramic camera is required to reach 20 million pixels; and debugging the device and setting parameters after the device is assembled;

(43) assisting, by auxiliary personnel, a tester in wearing the device on a back of the tester, adjusting laces and buttons of the device, to ensure that the device does not shake during normal walking, and adjusting a lens height to a human eye height of 1.6 m;

(44) walking, by a tester, at a constant speed of 1.0-1.5 m/s according to the planned real scene collection route to collect data; and

(45) inputting the collected data to the SuperMap three-dimensional data platform by using a computer.

Further, step (5) includes the following steps:

(51) arranging the planning scheme, extracting objects in the scheme that have a large volume and affect a landscape of the viewing corridor, such as terrains, architectures, trees, and roads, classifying the objects into layers, and successively naming the objects after terrain, architecture, tree, road, landscape, and others, and importing the data into the SuperMap three-dimensional data platform;

(52) combining, in the three-dimensional data platform, the planning scheme data extracted in (51) with the current three-dimensional real scene data obtained in step (4), and adjusting the coordinates, so that the two pieces of data are in a same coordinate system;

(53) checking model errors after the combination, and modifying the errors in the planning scheme, where if there is a difference between data about planned to-be-retained architectures and landscapes and a current situation, the real scene data is used; when data about a planned new architecture exceeds a boundary line, a position of the architecture is required to be adjusted; removing planned to-be-removed current road and architectures from the current data; and obtaining the planned three-dimensional model data;

(54) setting a plurality of viewing corridor points in the new three-dimensional model database according to the viewing corridor generated in step (3), generating, in the SuperMap database, a new urban viewing corridor after the planning simulation, and exporting the new urban viewing corridor.

Further, step (6) is implemented by using the following process:

outputting a view field image of the urban dynamic viewing corridor by using an externally connected dedicated drawing device, and inputting an urban dynamic viewing corridor at each designated measurement point and a number corresponding to the urban dynamic viewing corridor to an Excel form, to obtain standard measurement panel data, where the auxiliary device includes a measuring device, a built-in global positioning system (GPS) device of the measuring device, a fixing device of a gimbal tripod, a sunroof type or convertible mobile transportation device, a computer analysis device capable of image transmission and sharing, and a dedicated drawing device externally connected to a computer.

Beneficial effects: Compared to the related art, beneficial effects of the present invention are as follows:

1. Accuracy: According to the method of calculating and recognizing the current viewing corridor of the viewing point view field used in the present invention, a blocking point set is acquired by establishing a visual sphere, and the quantitative calculation and extraction of the three-dimensional view field are performed. In addition, the viewing corridor is strictly screened based on the numerical operation of the curvature, and an accurate viewing corridor of the current situation of the city is finally obtained. The present invention greatly improves the accuracy of visual perception evaluation, avoids the subjectivity of conventional manual methods for the recognition and evaluation of urban viewing corridors, and minimizes the errors of the evaluation and recognition calculation of the viewing corridor.

2. Authenticity: The present invention uses a wearable high-precision three-dimensional scanner, and has a high-precision lidar and a high-resolution panoramic camera. A collector enters and collects a real scene at a height of human sight and a constant speed. In this way, the shortcomings of ignoring human sight and static judgment in conventional GIS view field analysis method are overcome, and the authenticity of planning simulation and visual corridor analysis is ensured.

3. Interactivity: The previous analysis of urban viewing corridors mainly focuses on the research and determination of the current urban space, cannot effectively determine the impact of the planning scheme in the current urban viewing corridor space on the viewers, and cannot effectively guide the optimization and adjustment of planning and design. According to the present invention, a three-dimensional interactive display platform and the augmented reality technology are used based on input of the dynamic real scene, so as to effectively guarantee the implementation of planning simulation and satisfy user requirements. The present invention has interactive characteristics and provides a basic rational support for further optimization and decision-making of urban planning and design.

### BRIEF DESCRIPTION OF THE DRAWINGS

The sole FIGURE is a flowchart of the present invention.

### DETAILED DESCRIPTION

The present invention is further described in detail with reference to the accompanying drawings. As shown in the FIGURE, a dynamic interactive simulation method for recognition and planning of an urban viewing corridor provided in the present invention specifically includes the following steps.

Step 1: Construct a sand table of morphology data of an urban space around an urban viewing point based on vector data including terrains, architectures, and roads.

1.1) Acquire coordinates 0 (x, y, z) of the viewing point, where (x, y) are coordinate values of a plane where the viewing point is located, and z is a plane height of a highest point of a scene object where the viewing point is located, and acquire two-dimensional vector data including information about urban terrains, architectures, and roads within a certain range around an observation point (a specific position where a viewing point is viewed), where the architecture data is a closed polygon including information about a quantity of architecture storeys, and the road data includes information about a centerline, a road width, and a road elevation of each road.

1.2) Adjust coordinates of the vector data to be consistent, load the coordinates into a SuperMap platform, and perform stretching by using a storey height of 3 m based on the information about the architecture storeys, to obtain a three-dimensional architecture model; and generate a three-dimensional road model based on the information about the road centerline and the road elevation point and the road width value, so as to establish a basic sand table of morphology data of an urban space.

1.3) Rasterize, based on the obtained basic sand table of the morphology data of the urban space, a surface without the three-dimensional architecture model that is deemed a ground plane.

Step 2: Create a visual sphere according to the viewing point and a maximum visual distance, calculate a blocking point set, acquire a three-dimensional view field of the viewing point, and obtain an effective projection plane of a sight line of the viewing point.

2.1) Create a visual sphere according to the coordinates 0 (x, y, z) of the viewing point, create the visual sphere by using a maximum visible distance R in a current environment as a radius, and draw a vertical line from a center of the sphere to a surface of the sphere at an interval of an azimuth angle α, where the vertical line is deemed a sight line for observing the viewing point.

2.2) Acquire a point of intersection O₁(x₁, y₁, z₁) between each generated azimuth line and the covered three-dimensional architecture model in the sphere, where the point of intersection is deemed a blocking point of the sight line, so as to form a blocking point set N{O₁, O₂, O₃, On}; and connect all blocking points in the point set to acquire the three-dimensional view field of the viewing point.

2.3) Perform upward lifting in unit of 1.6 m based on ground plane grids of the sand table, where the obtained plane grids are deemed a human viewing plane where the observation point is located; and perform projection onto the human viewing plane in a y-axis direction according to the three-dimensional view field of the viewing point, where an obtained projection plane is denoted as the effective projection plane of the sight line of the viewing point.

Step 3: Extract a visual three-dimensional road model, calculate projection curvatures of road centerlines at points equidistant from each other, and screen and recognize a viewing corridor.

3.1) Calculate a point of intersection of the obtained effective projection plane of the sight line of the viewing point and the three-dimensional road model, and intercept a road unit model in an effective sight line.

3.2) Extract a centerline of the intercepted road unit model, dot the centerline equidistantly at an interval of 2 m to obtain the point set n {P₁, P_{2,} P₃, . . . , Pn}, where coordinates of a midpoint Pᵢ are (Xᵢ, Yᵢ, Zᵢ), and connect adjacent points in the point set to form a continuous polyline. On this basis, a projection curvature Kₚ of the centerline on a horizontal plane is calculated, and the calculation formula is as follows:

$${K}_{P} = ( {\sum }_{i = 1}^{n - 1} arccos \frac{{r}_{i} \cdot {r}_{i + 1}}{\vert {r}_{i} \vert \cdot \vert {r}_{i + 1} \vert} ) {( {\sum }_{i = 1}^{n} \vert {r}_{i} \vert )}^{- 1}$$

where n is a total quantity of points in the set {P₁, P₂, P₃, . . . , Pₙ}, i=0, 1, . . . , n, the points are arranged in ascending order according to a coordinate z of the midpoint Pᵢ (Xᵢ, Yᵢ, Zᵢ), rᵢ is a vector of connecting adjacent points, and

rᵢ=\vec{Pᵢ₋ₗPᵢ}=(xᵢ−xᵢ₋ₗ, yᵢ−yᵢ₋ₗ, zᵢ−zᵢ₋ₗ) , i=1,2 , . . . , n.

3.3) Eliminate a three-dimensional road model having Kₚ>4/km according to the calculated road projection curvature, and deem the remaining road three-dimensional road model to be a current viewing corridor of the viewing point.

Step 4: Collect a real scene of a recognized current urban landscape corridor space scene by using a backpack three-dimensional laser scanner-ZEB, and input the collected real scene to a three-dimensional interactive display platform.

4.1) Input the viewing corridor automatically recognized in step 3 to the two-dimensional plane database, place a 5 m*5 m flat grid in the database, and determine a real scene collection route according to the viewing corridor space in the planning scheme, so as to serially connect, by a shortest path, all streets and public spaces where the viewing corridor is located.

4.2) Assemble a wearable high-precision three-dimensional scanner at a starting point of the collection route, where the scanner is required to have a lidar and a panoramic camera for collection, the scanning accuracy of the lidar is required to reach 300,000 dots per second, and a resolution of the panoramic camera is required to reach 20 million pixels. It is also necessary to debug the device and set parameters after the device is assembled. The parameters specifically include battery detection, GPS calibration, and camera settings. The camera shooting frequency needs to be set to 7 real scene photos per second.

4.3) Auxiliary personnel assists a tester in wearing the device on a back of the tester, adjusts laces and buttons of the device, to ensure that the device does not shake during normal walking, and adjusts a lens height to a human eye height of 1.6 m.

4.4) A tester walks at a constant speed of 1.0-1.5 m/s according to the planned real scene collection route to collect data. During the test, the tester is not allowed to shake the body or change the speed drastically, and the auxiliary personnel should follow the tester during the whole test, so as to provide language assistance at any time.

4.5) Remove the device and input the collected data to the SuperMap three-dimensional data platform by using a computer upon completion of walking.

Step 5: Input a new planning scheme to the three-dimensional interactive display platform, and simulate an urban viewing corridor with the planning scheme superimposed.

5.1) Arrange the planning scheme, extract objects in the scheme that have a large volume and affect a landscape of the viewing corridor, such as the terrains, architectures, trees, roads, and characteristic landscapes, classify the objects into layers, and successively name the objects after terrain, architecture, tree, road, landscape, and others, and import the data into the SuperMap three-dimensional data platform.

5.2) Combine, in the three-dimensional data platform, the planning scheme data extracted in 5.1 with the current three-dimensional real scene data obtained in step 4, and adjust the coordinates, so that the two pieces of data are in a same coordinate system.

5.3) Check model errors after the combination, and modify the errors in the planning scheme. If there is a difference between data about planned to-be-retained architectures and landscapes and a current situation, the real scene data is used. When data about a planned new architecture exceeds a boundary line, a position of the architecture is required to be adjusted. The planned to-be-removed current roads and architectures need to be removed from the current data. Finally, the planned three-dimensional model data is obtained.

5.4) According to the viewing corridor generated in step 3, set a plurality of viewing corridor points in the new three-dimensional model database, generate, in the SuperMap database, a new urban viewing corridor on which planning simulation is performed, and export the new urban viewing corridor.

Step 6: Output, by using augmented reality glasses, a dynamic interactive VR scene of the urban viewing corridor space after the urban planning scheme is superimposed.

6.1) Output a view field image of the urban dynamic viewing corridor by using an externally connected dedicated drawing device, and input the urban dynamic viewing corridor at each designated measurement point and a number corresponding to the urban dynamic viewing corridor to an Excel form, to obtain standard measurement panel data.

6.2) The auxiliary device includes a measuring device, a built-in global positioning system (GPS) device of the measuring device, a fixing device of a gimbal tripod, a sunroof type or convertible mobile transportation device, a computer analysis device capable of image transmission and sharing, and a dedicated drawing device externally connected to a computer. The measuring device is required to be equipped with a special lens for shooting. The lens is characterized by an entrained-type wide-angle macro fisheye lens having at least 8 million pixels for shooting.

What is claimed is:

1. A dynamic interactive simulation method for recognition and planning of an urban viewing corridor, the method comprising the following steps:
(1) constructing a sand table of morphology data of an urban space around an urban viewing point based on vector data comprising terrains, architectures, and roads;
(2) creating a visual sphere according to the viewing point and a maximum visual distance, calculating a blocking point set, acquiring a three-dimensional view field of the viewing point, and obtaining an effective projection plane of a sight line of the viewing point;
(3) extracting a visual three-dimensional road model, calculating projection curvatures of road centerlines at points equidistant from each other, and screening and recognizing a viewing corridor;
(4) collecting a real scene of a recognized current urban viewing corridor space by using a backpack three-dimensional laser scanner, and inputting the collected real scene to a three-dimensional interactive display platform;
(5) inputting a new planning scheme to the three-dimensional interactive display platform, and simulating an urban viewing corridor with the planning scheme superimposed; and
(6) outputting, by using augmented reality glasses, a dynamic interactive VR scene of the urban viewing corridor space after the urban planning scheme is superimposed.

2. The dynamic interactive simulation method for recognition and planning of an urban viewing corridor according to claim 1, wherein step (1) comprises the following steps:
(11) acquiring coordinates 0 (x, y, z) of the viewing point, wherein (x, y) are coordinate values of a plane where the viewing point is located, and z is a plane height of a highest point of a scene object where the viewing point is located; acquiring two-dimensional vector data comprising information about an urban terrain, an architecture, and a road within a certain range around an observation point, wherein the architecture data is a closed polygon and comprises information about a quantity of architecture storeys, and the road data comprises information about a centerline, a road width, and a road elevation point of each road;
(12) adjusting coordinates of the vector data to be consistent, loading the coordinates into a SuperMap platform, and performing stretching by using a storey height of 3 m based on the information about the architecture storeys, to obtain a three-dimensional architecture model; and generating a three-dimensional road model based on the information about the road centerline and the road elevation point and the road width value, so as to establish a basic sand table of the morphology data of the urban space; and
(13) rasterizing, based on the obtained basic sand table of the morphology data of the urban space, a surface without the three-dimensional architecture model that is deemed a ground plane.

3. The dynamic interactive simulation method for recognition and planning of an urban viewing corridor according to claim 1, wherein step (2) comprises the following steps:
(21) creating a visual sphere according to the coordinates O (x, y, z) of the viewing point: creating the visual sphere by using a maximum visible distance R in a current environment as a radius, and drawing a vertical line from a center of the sphere to a surface of the sphere at an interval of an azimuth angle α, wherein the vertical line is deemed the sight line for observing the viewing point;
(22) acquiring a point of intersection Oᵢ (x₁, y₁, z₁) of each generated azimuth line and the covered three-dimensional architecture model in the sphere, wherein the point of intersection is deemed the blocking point of the sight line, and forming a blocking point set N{O₁, O₂, O₃, . . . , On}; and connecting all blocking points in the point set to acquire the three-dimensional view field of the viewing point; and
(23) performing upward lifting in unit of 1.6 m based on ground plane grids of the sand table, wherein the obtained plane grids are deemed a human viewing plane where the observation point is located; and performing projection onto the human viewing plane in a y-axis direction according to the three-dimensional view field of the viewing point, wherein an obtained projection plane is denoted as the effective projection plane of the sight line of the viewing point.

4. The dynamic interactive simulation method for recognition and planning of an urban viewing corridor according to claim 1, wherein step (3) comprises the following steps:
(31) calculating a point of intersection of the obtained effective projection plane of the sight line of the viewing point and the three-dimensional road model, and intercepting a road unit model in an effective sight line;
(32) extracting a centerline of the intercepted road unit model, and dotting the centerline equidistantly at an interval of 2 m to obtain a point set n{P₁, P_{2,} P₃, . . . , Pₙ}, wherein coordinates of a midpoint Pᵢ are (Xᵢ, Yᵢ, Zᵢ), and connecting adjacent points in the point set to form a continuous polyline; calculating a projection curvature Kₚ of the centerline on a horizontal plane, wherein a calculation formula is as follows:
$${K}_{P} = ( {\sum }_{i = 1}^{n - 1} arccos \frac{{r}_{i} \cdot {r}_{i + 1}}{\vert {r}_{i} \vert \cdot \vert {r}_{i + 1} \vert} ) {( {\sum }_{i = 1}^{n} \vert {r}_{i} \vert )}^{- 1}$$
wherein n is a total quantity of points in the set {P₁, P₂, P₃, . . . , Pn}, i=0, 1, . . . , n, the points are arranged in ascending order according to a coordinate z of the midpoint Pᵢ (Xᵢ, Yᵢ, Zᵢ), rᵢ is a vector of a line connecting adjacent points, and
rᵢ=\vec{Pᵢ₋ₗPᵢ}=(xᵢ−xᵢ₋ₗ, yᵢ−yᵢ₋ₗ, zᵢ−zᵢ₋ₗ) , i=1,2 , . . . , n; and
(33) eliminating a three-dimensional road model having Kₚ>4/km according to the calculated road projection curvature, and using a remaining three-dimensional road model as a current viewing corridor of the viewing point.

5. The dynamic interactive simulation method for recognition and planning of an urban viewing corridor according to claim 1, wherein step (4) comprises the following steps:
(41) inputting the viewing corridor automatically recognized in step (3) to a two-dimensional plane database, placing a 5 m*5 m flat grid in the database, and determining a real scene collection route according to the viewing corridor space in the planning scheme, so as to serially connect, by a shortest path, all streets and public spaces where the viewing corridor is located;
(42) assembling a wearable high-precision three-dimensional scanner at a starting point of the collection route, wherein the scanner is required to have a lidar and a panoramic camera for collection, the scanning accuracy of the lidar is required to reach 300,000 dots per second, and a resolution of the panoramic camera is required to reach 20 million pixels; and debugging the device and setting parameters after the device is assembled;
(43) assisting, by auxiliary personnel, a tester in wearing the device on a back of the tester, adjusting laces and buttons of the device, to ensure that the device does not shake during normal walking, and adjusting a lens height to a human eye height of 1.6 m;
(44) walking, by a tester, at a constant speed of 1.0-1.5 m/s according to the planned real scene collection route to collect data; and
(45) inputting the collected data to the SuperMap three-dimensional data platform by using a computer.

6. The dynamic interactive simulation method for recognition and planning of an urban viewing corridor according to claim 1, wherein step (5) comprises the following steps:
(51) arranging the planning scheme, extracting objects in the scheme that have a large volume and affect a landscape of the viewing corridor, such as terrains, architectures, trees, and roads, classifying the objects into layers, and successively naming the objects after terrain, architecture, tree, road, landscape, and others, and importing the data into the SuperMap three-dimensional data platform;
(52) combining, in the three-dimensional data platform, the planning scheme data extracted in (51) with the current three-dimensional real scene data obtained in step (4), and adjusting the coordinates, so that the two pieces of data are in a same coordinate system;
(53) checking model errors after the combination, and modifying the errors in the planning scheme, wherein if there is a difference between data about planned to-be-retained architectures and landscapes and a current situation, the real scene data is used; and when data about a planned new architecture exceeds a boundary line, a position of the architecture is required to be adjusted; removing planned to-be-removed current road and architectures from the current data; and obtaining the planned three-dimensional model data;
(54) setting a plurality of viewing corridor points in the new three-dimensional model database according to the viewing corridor generated in step (3), generating, in the SuperMap database, a new urban viewing corridor after the planning simulation, and exporting the new urban viewing corridor.

7. The dynamic interactive simulation method for recognition and planning of an urban viewing corridor according to claim 1, wherein step (6) is implemented by using the following process:
outputting a view field image of the urban dynamic viewing corridor by using an externally connected dedicated drawing device, and inputting an urban dynamic viewing corridor at each designated measurement point and a number corresponding to the urban dynamic viewing corridor to an Excel form, to obtain standard measurement panel data, wherein the auxiliary device comprises a measuring device, a built-in global positioning system (GPS) device of the measuring device, a fixing device of a gimbal tripod, a sunroof type or convertible mobile transportation device, a computer analysis device capable of image transmission and sharing, and a dedicated drawing device externally connected to a computer.
